(19) United States
(12) Patent Application Publication
(10) Pub. No.: US 2017/0210021 A1
(43) Pub. Date: Jul. 27, 2017

(54) Knife Spine Sleeve Attachment Apparatus and Methods of Using the Same

(71) Applicant: Jason Lee, Wonder Lake, IL (US)

(72) Inventor: Jason Lee, Wonder Lake, IL (US)

(21) Appl. No.: 15/007,576

(22) Filed: Jan. 27, 2016

(51) Int. Cl. B26B 29/02; B26B 3/00

(52) U.S. Cl. CPC B26B 29/02; B26B 3/00

(57) ABSTRACT

The present invention relates to a knife spline sleeve attachment apparatus. More specifically, the knife spine sleeve attachment apparatus comprises a body portion comprising a first side and a second side and a channel between the first side and the second side, the channel configured to be placed on the spine and held on the blade of a knife, the body portion further comprising an upper element above the channel and connecting the first side to the second side, and extending above the spine of the knife when placed and held thereon to aid a knife user in holding and utilizing the knife to cut food product. Methods of using the same are further provided.

### TECHNICAL FIELD

The present invention relates to a knife spline sleeve attachment apparatus. More specifically, the knife spine sleeve attachment apparatus comprises a body portion comprising a first side and a second side and a channel between the first side and the second side, the channel configured to be placed on the spine and held on the blade of a knife, the body portion further comprising an upper element above the channel and connecting the first side to the second side, and extending above the spine of the knife when placed and held thereon to aid a knife user in holding and utilizing the knife to cut food product. Methods of using the same are further provided.

### BACKGROUND

Chefs and cooks frequently utilize knives in the cutting and preparation of food products. Indeed, a typical knife 10 used in food preparation is shown in FIG. 1, having a blade 12 and a handle 14. The blade comprises a cutting edge 16, a spine 18, a tip 20 and a heel 22. The handle 14 typically comprises a pair of handle elements 24 held over a metal handle portion 26 via rivets 28, and a butt 30. The transition portion between the blade 12 and the handle 14 is known as the bolster 32.

The proper usage of a knife in the preparation of food items typically involves a specific manner of holding the knife to ensure that the user has optimal control over the knife when cutting foods. Specifically, FIG. 2 illustrates a prior art view of the proper technique to hold a knife when cutting food. Specifically, the user's hand 40 grips the knife and places his or her thumb 42 on one side of the blade and his or her forefinger 44 on the other side of the blade with the spine of the knife disposed in the area of the hand 46 between the thumb and the forefinger. The three remaining fingers 48, including the middle finger, the ring finger and the little finger, grasp the handle 16 of the knife 10.

This handling technique provides a great amount of control of the knife when used in food preparation. However, over time, the user may experience discomfort in the area 46 between the thumb 42 and the foreigner 44, caused by relatively sharp edges of the spine of the knife repeatedly rubbing against the user's skin. Using the knife for an extended period of time may result in irritation, redness, swelling, blisters, cramping, callouses and other like discomfort for a user, specifically from the rubbing of the spine 18 of the knife on the user's skin.

A need, therefore, exists for a knife spine sleeve attachment apparatus and methods of using the same that aids a user in utilizing a knife for extended periods of time, while holding the knife in the proper food cutting position. Specifically, a need exists for a knife spine sleeve attachment apparatus and methods of using the same that prevent or minimize irritation of a user's hand when in use for extended periods of time.

More specifically, a need exists for a knife spine sleeve attachment apparatus and methods of using the same that provides a relatively smooth surface on the spine of a knife that prevents or minimizes discomfort in a user. More specifically, a need exists for a knife spine sleeve attachment apparatus and methods of using the same that eliminates and covers harsh edges of a knife spine.

In addition, a need exists for a knife spine sleeve attachment apparatus and methods of using the same that is attachable and removable from the spine of a knife to aid a user in preventing or minimizing discomfort when using the knife. Moreover, a need exists for a knife spine sleeve attachment apparatus and methods of using the same that provides a firm fit that remains attached to the spine of the knife when in use.

### SUMMARY OF THE INVENTION

The present invention relates to a knife spline sleeve attachment apparatus. More specifically, the knife spine sleeve attachment apparatus comprises a body portion comprising a first side and a second side and a channel between the first side and the second side, the channel configured to be placed on the spine and held on the blade of a knife, the body portion further comprising an upper element above the channel and connecting the first side to the second side, and extending above the spine of the knife when placed and held thereon to aid a knife user in holding and utilizing the knife to cut food product. Methods of using the same are further provided.

To this end, in an embodiment of the present invention, a knife spine attachment apparatus comprising: a body comprising a first end, a second end, a length between the first end and the second end, and a width, and a slot disposed in a bottom of the body running from the first end to the second end of the body, wherein the body is configured to be disposed on a spine of a knife blade wherein when disposed on a spine of a knife blade, the spine of the knife blade fits within the slot.

In an embodiment, the body has a rounded top.

In an embodiment, the body is torpedo-shaped.

In an embodiment, the first and second ends are rounded.

In an embodiment, the slot is sized to receive the spine of a knife blade.

In an embodiment, the knife spine attachment apparatus further comprises: a gripping material on at least one of the sides of the slot within the body.

In an embodiment, the griping material is an elastomeric material.

In an embodiment, the gripping material is disposed on opposite sides of the slot.

In an embodiment, the knife spine attachment apparatus further comprises: an aperture in a side of the body running from the side of the body to the slot; and a bolt disposed through the aperture, wherein the bolt is configured to tighten on a blade disposed within the slot.

In an embodiment, the knife spine attachment apparatus further comprises: a gripping material on an inside surface of the slot on the side having the aperture therein.

In an embodiment, the knife spine attachment apparatus further comprises: a knife, wherein the spine of the knife is positioned within the slot.

In an alternate embodiment of the present invention, a method of using a knife spine attachment apparatus on a knife is provided. The method comprises the steps of: providing a knife spine attachment apparatus comprising a body comprising a first end, a second end, a length between the first end and the second end, and a width, and a slot disposed in a bottom of the body running from the first end to the second end of the body; providing a knife having a spine and a blade; and placing the spine of the knife into the slot of the attachment apparatus.

In an embodiment, the body has a rounded top, and rounded first and second ends.

In an embodiment, the body is torpedo-shaped.

In an embodiment, the slot is sized to receive the spine of a knife blade.

In an embodiment, the attachment apparatus further comprises a gripping material on at least one of the sides of the slot within the body.

In an embodiment, the gripping material is an elastomeric material.

In an embodiment, the gripping material is disposed on opposite sides of the slot.

In an embodiment, the attachment apparatus further comprises an aperture in a side of the body running from the side of the body to the slot, and a bolt disposed through the aperture, wherein the bolt is configured to tighten on a blade disposed within the slot, and the method further comprises the step of: turning the bolt to tighten the bolt upon the blade of the knife.

In an embodiment, the attachment apparatus comprises a gripping material on an inside surface of the slot on the side having the aperture therein.

It is, therefore, an advantage and objective of the present invention to provide a knife spine sleeve attachment apparatus and methods of using the same that aids a user in utilizing a knife for extended periods of time, while holding the knife in the proper food cutting position.

Specifically, it is an advantage and objective of the present invention to provide a knife spine sleeve attachment apparatus and methods of using the same that prevent or minimize irritation of a user's hand when in use for extended periods of time.

More specifically, it is an advantage and objective of the present invention to provide a knife spine sleeve attachment apparatus and methods of using the same that provides a relatively smooth surface on the spine of a knife that prevents or minimizes discomfort in a user.

More specifically, it is an advantage and objective of the present invention to provide a knife spine sleeve attachment apparatus and methods of using the same that eliminates and covers harsh edges of a knife spine.

In addition, it is an advantage and objective of the present invention to provide a knife spine sleeve attachment apparatus and methods of using the same that is attachable and removable from the spine of a knife to aid a user in preventing or minimizing discomfort when using the knife.

Moreover, it is an advantage and objective of the present invention to provide a knife spine sleeve attachment apparatus and methods of using the same that provides a firm fit that remains attached to the spine of the knife when in use.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates a prior art view of a knife.

FIG. 2 illustrates a prior art view of a user holding a knife properly to cut food products.

FIGS. 3A-3C illustrate a knife spine sleeve attachment apparatus in an embodiment of the present invention.

FIG. 4 illustrates a knife spine sleeve attachment apparatus disposed on a knife in an embodiment of the present invention.

FIGS. 5A-5B illustrate a knife spine sleeve attachment apparatus in an alternate embodiment of the present invention.

FIGS. 6A-6C illustrate a knife spine sleeve attachment apparatus in an alternate embodiment of the present invention.

FIG. 7 illustrates a knife spine sleeve attachment apparatus in an alternate embodiment of the present invention.

FIG. 8 illustrates a user utilizing a knife having a knife spine sleeve attachment apparatus in an embodiment of the present invention.

FIG. 9 illustrates a knife spine sleeve attachment apparatus in yet another alternate embodiment of the present invention.

FIG. 10 illustrates a bottom view of a knife spine sleeve attachment apparatus in another embodiment of the present invention.

FIG. 11 illustrates a perspective view of a knife spine sleeve attachment apparatus on a spine of a knife in an embodiment of the present invention.

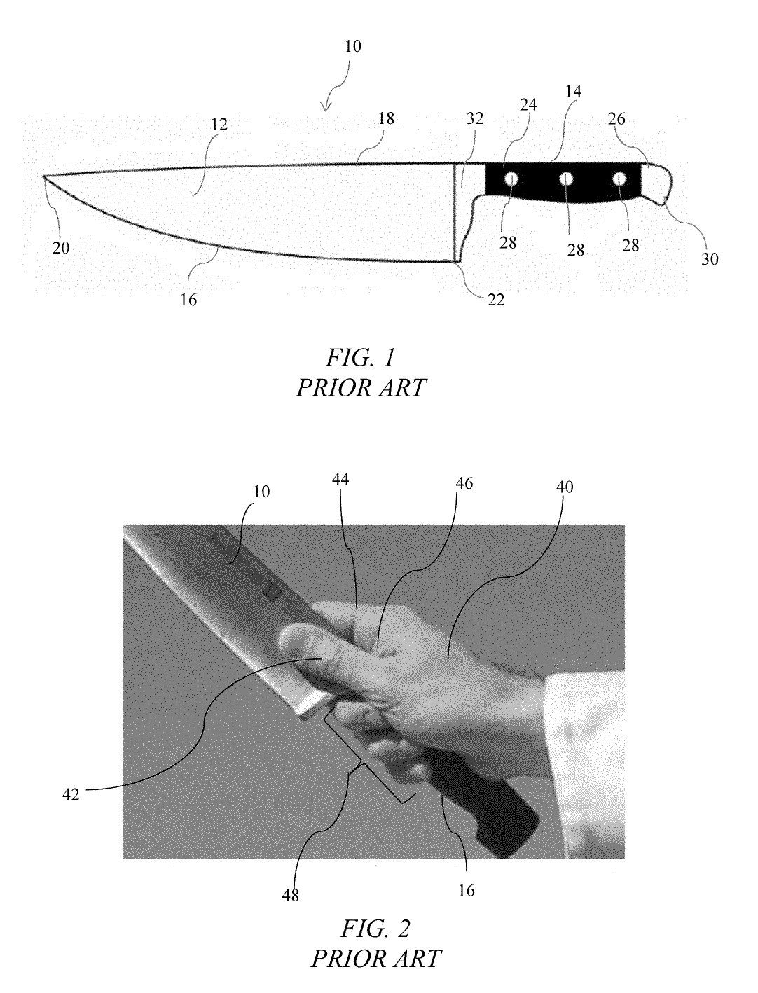

### DETAILED DESCRIPTION OF THE PRESENTLY PREFERRED EMBODIMENTS

The present invention relates to a knife spline sleeve attachment apparatus. More specifically, the knife spine sleeve attachment apparatus comprises a body portion comprising a first side and a second side and a channel between the first side and the second side, the channel configured to be placed on the spine and held on the blade of a knife, the body portion further comprising an upper element above the channel and connecting the first side to the second side, and extending above the spine of the knife when placed and held thereon to aid a knife user in holding and utilizing the knife to cut food product. Methods of using the same are further provided.

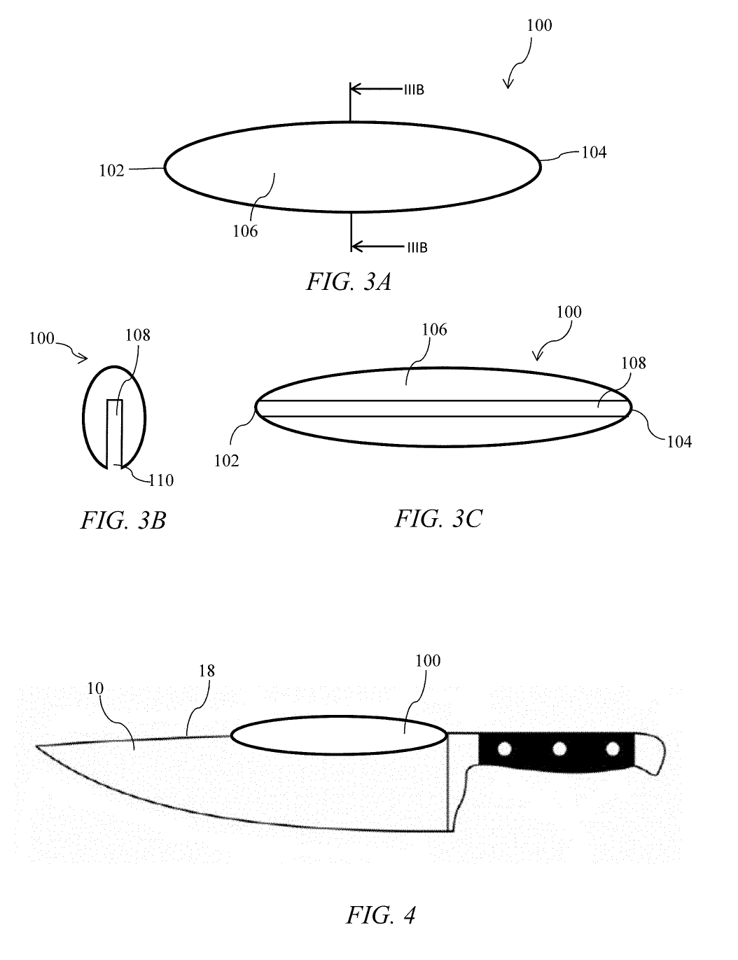

Now referring to the figures, wherein like numerals refer to like parts, FIGS. 3A-3C illustrate a knife spine sleeve attachment apparatus 100 in an embodiment of the present invention. The apparatus 100 may comprise an oval shaped sleeve having a first rounded end 102, a second rounded end 104 and a body 106 therebetween. Further, in a preferred embodiment, the top and/or bottom of the body 106 may further be rounded, providing the apparatus 100 with a torpedo shape. However, it should be noted that the apparatus 100 may be any shape, such as with squared off edges, or other shapes apparent to one of ordinary skill in the art.

As illustrated in FIG. 3B, a cross-sectional view of the apparatus 100 along lines IIIB-IIIB from FIG. 3A, a longitudinal slot 108 may be disposed in the apparatus 100 between the first end 102 and the second end 104, having an opening 110 on a bottom thereof. FIG. 3C is a bottom view of the apparatus 100 showing the slot 108.

The apparatus 100 may be made from a resilient material, such as plastic, rubber, metal, wood, or any other material useful for the present invention. Specifically, the apparatus 100 may preferably have a smooth outer surface that is comfortable to a user when used in accordance with the present disclosure.

Specifically, as illustrated in FIG. 4, the apparatus 100 may be placed over the spine 18 of knife 10, whereby the spine of the blade 12 fits within the slot 108 through the opening 110.n The apparatus 100 may be held on the spine 18 of the blade 12 due to the size of the slot matching, generally, with the size of the width of the spine. As such, the apparatus 100 may be resilient but expansive to firmly hold onto the spine of 18 of the blade 12. Thus, a user, having placed the apparatus 100 on the knife 10 may be able to utilize the knife without discomfort. Specifically, FIG. 8 illustrates the apparatus 100 in use with a user's hand 40, holding the knife in the proper food cutting position. The smooth, round surface of the apparatus 100 may allow the user to utilize the knife for an extended period of time without discomfort.

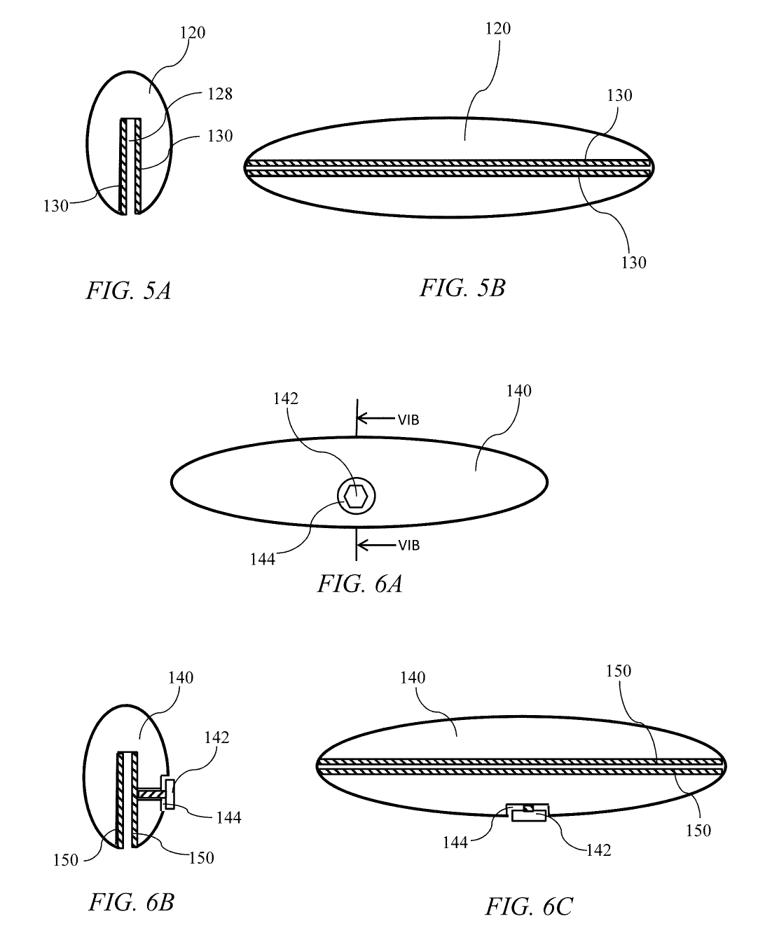

FIGS. 5A-5B, 6A-6C and 7 illustrate alternate embodiments of the present invention. Specifically, FIG. 5A illustrates a knife spine sleeve attachment apparatus 120 having a rubbery or elastomeric sheath, coating, film or layer 130 within slot 128 for aiding in gripping the spine 18 of the knife 10. The gripping sheath 130 may be provided on opposite sides of the slot 128 for contacting the opposite sides of the blade 12 of the knife 10. The gripping sheath 130 may aid in ensuring that the apparatus 120 is held firmly on the knife 10. FIG. 5B illustrates a bottom view of the apparatus 120, showing the gripping sheath 130 disposed fully across the longitudinal slot 128 on opposite sides thereof. It should be noted, in an alternate embodiment, that the gripping sheath 130 may not be a continuous layer or film that runs through the entirety of the length of the slot 128, but may be placed discontinuous, or placed in one or more several locations within the slot 128.

FIGS. 6A, 6B and 6C illustrate a further alternate embodiment of the present invention of an apparatus 140, similar to the apparatus 120 described above, but further having a bolt, pin or screw 142 disposed within a seat 144 that may be utilized to set the apparatus 140 firmly on the blade 12 of the knife 10 when in use. The apparatus 140 may be placed over the spine 18 of the blade 12 and the bolt, pin or screw 142 may be tightened so that the terminal end of the bolt, pin or screw 142 may be pushed against the blade 12. Alternatively, the bolt, pin or screw 142 may push gripping sheath 150 into the blade 12 of the knife 12, thereby providing a firm hold of the apparatus 140 on the blade 12. FIG. 6C illustrates a bottom view of the apparatus 140.

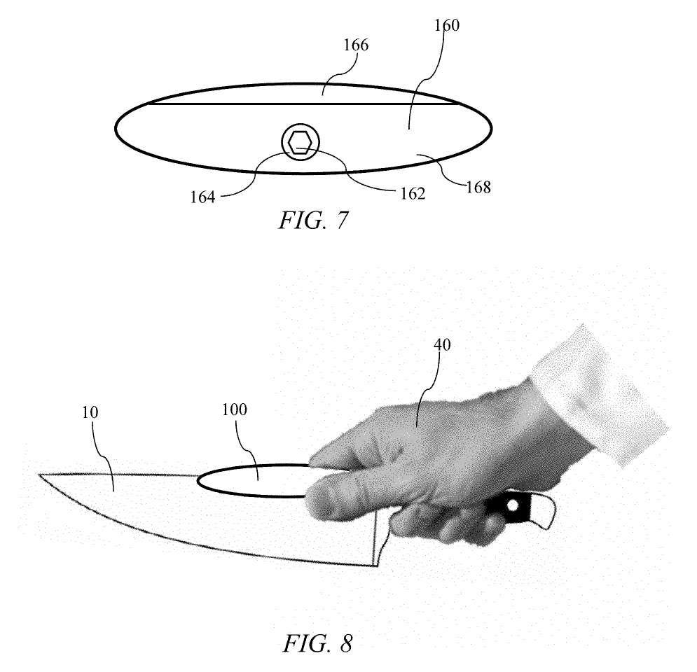

FIG. 7 illustrates another embodiment of the present invention of an apparatus 160 having bolt, pin or screw 162 disposed within seat 164, which may allow the apparatus to be held onto the blade 12 of the knife 10, as described above. A contact section 166 may be provided for contacting a user's hand when in use, as shown in FIG. 8. The contact section 166 may be made of a different material than the remainder 168 of the apparatus 160. For example, the remainder 168 of the apparatus may be made of a hard plastic material while the contact section 166 may be made from a soft, elastic material that is comfortable on a user's hand. Thus, the present invention may utilize combinations of materials to impart both resiliency and toughness, and softness and comfort when used on a knife 10, as described herein.

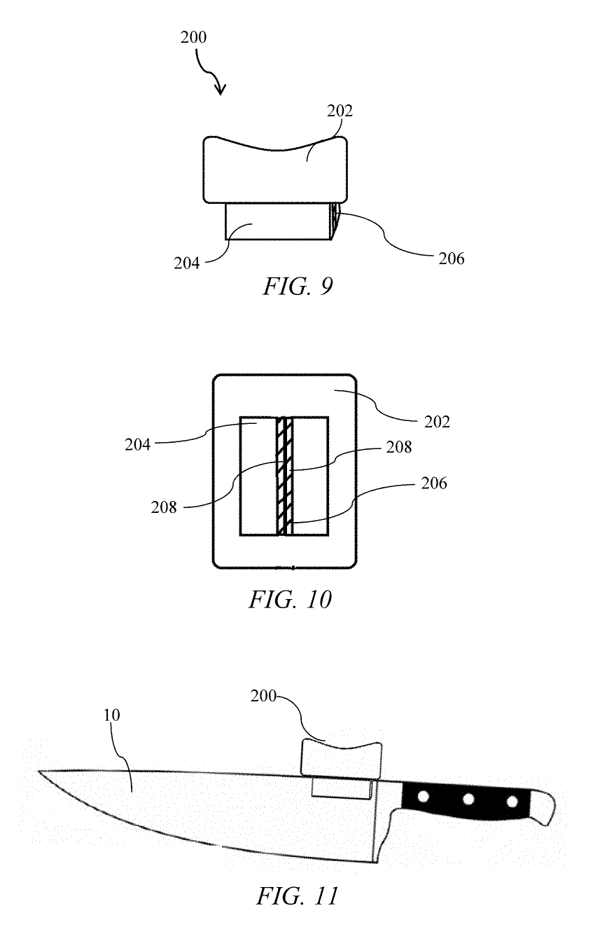

In another embodiment of the present invention, a knife spine sleeve attachment apparatus 200 is illustrated in FIG. 9. The knife spine sleeve attachment apparatus 200 comprises an upper portion 202 and a lower portion 204. The upper portion comprises an upper surface having an indented or saddle-shaped contour, which may more easily engage a user's hand when the apparatus 200 is disposed on the spine of a knife 10, as illustrated in FIG. 11. The lower portion 204 comprises a slit 206 that may optionally comprise a resilient, elastomeric material 208 on opposite sides thereof (as illustrated in FIG. 10) to aid in holding the apparatus 200 on the spine of the knife 10 when in use.

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are nonlimiting, and it should be noted that claim limitations presented herein are not meant to describe the invention as a whole. Moreover, the invention illustratively disclosed herein suitably may be practiced in the absence of any element which is not specifically disclosed herein.

I claim:

1. A knife spine attachment apparatus comprising:
a body comprising a first end, a second end, a length between the first end and the second end, and a width, and a slot disposed in a bottom of the body running from the first end to the second end of the body, wherein the body is configured to be disposed on a spine of a knife blade wherein when disposed on a spine of a knife blade, the spine of the knife blade fits within the slot.

2. The knife spine attachment apparatus of claim 1 wherein the body has a top surface selected from the group consisting of a rounded surface and a saddle-shaped surface.

3. The knife spine attachment apparatus of claim 1 wherein the body is torpedo-shaped.

4. The knife spine attachment apparatus of claim 1 wherein the first and second ends are rounded.

5. The knife spine attachment apparatus of claim 1 wherein the slot is sized to receive the spine of a knife blade.

6. The knife spine attachment apparatus of claim 1 further comprising:
a gripping material on at least one of the sides of the slot within the body.

7. The knife spine attachment apparatus of claim 6 wherein the griping material is an elastomeric material.

8. The knife spine attachment apparatus of claim 6 wherein the gripping material is disposed on opposite sides of the slot.

9. The knife spine attachment apparatus of claim 1 further comprising:
an aperture in a side of the body running from the side of the body to the slot; and
a bolt disposed through the aperture, wherein the bolt is configured to tighten on a blade disposed within the slot.

10. The knife spine attachment apparatus of claim 9 further comprising:
a gripping material on an inside surface of the slot on the side having the aperture therein.

11. The knife spine attachment apparatus of claim 1 further comprising:
a knife, wherein the spine of the knife is positioned within the slot.

12. A method of using a knife spine attachment apparatus on a knife comprising the steps of:
providing a knife spine attachment apparatus comprising a body comprising a first end, a second end, a length between the first end and the second end, and a width, and a slot disposed in a bottom of the body running from the first end to the second end of the body;
providing a knife having a spine and a blade;
placing the spine of the knife into the slot of the attachment apparatus.

13. The method of claim 12 wherein the body has a top surface selected from the group consisting of a rounded surface and a saddle-shaped surface.

14. The method of claim 12 wherein the body is torpedo-shaped.

15. The method of claim 12 wherein the slot is sized to receive the spine of a knife blade.

16. The method of claim 12 wherein the attachment apparatus further comprises a gripping material on at least one of the sides of the slot within the body.

17. The method of claim 16 wherein the griping material is an elastomeric material.

18. The method of claim 12 wherein the gripping material is disposed on opposite sides of the slot.

19. The method of claim 12 wherein the attachment apparatus further comprises an aperture in a side of the body running from the side of the body to the slot, and a bolt disposed through the aperture, wherein the bolt is configured to tighten on a blade disposed within the slot, and the method further comprises the step of:
turning the bolt to tighten the bolt upon the blade of the knife.

20. The method of claim 19 wherein the attachment apparatus comprises a gripping material on an inside surface of the slot on the side having the aperture therein.
